(19) United States
(12) Patent Application Publication
(10) Pub. No.: US 2016/0351038 A1
(43) Pub. Date: Dec. 1, 2016

(54) SYSTEM FOR MEDICAL DEVICE SOFTWARE ALERT HIERARCHY MANAGEMENT

(71) Applicants: Rama Madugula, Royal Oak, MI (US); Anup Sabharwal, Miami, FL (US); Sankar Majeti, Rochester Hills, MI (US); Murty Madugula, Rochester Hills, MI (US)

(72) Inventors: Rama Madugula, Royal Oak, MI (US); Anup Sabharwal, Miami, FL (US); Sankar Majeti, Rochester Hills, MI (US); Murty Madugula, Rochester Hills, MI (US)

(73) Assignee: MIDWEST BUSINESS ASSOCIATES, INC., Rochester Hills, MI (US)

(21) Appl. No.: 14/724,854

(22) Filed: May 29, 2015

(51) Int. Cl. G08B 21/04; G06F 19/00

(52) U.S. Cl. CPC G08B 21/0453; G06F 19/3418

(57) ABSTRACT

Disclosed is a system that monitors changes in the health of a patient by use of a computer program that generates both a hierarchy of software alert levels and a hierarchy of software alert urgencies to notify stakeholders in a patient's medical condition of unusual changes in the patient's condition. In the specific case of diabetes, such a system may create and manage alerts through a hierarchy that relates to a patient's blood sugar level, his weight, and/or the amount of medication delivered by a pump at any one time or over a given time period.

The present invention therefore provides improvement to a patient's long-term health and reduced costs of a patient's treatment regimen.

### BACKGROUND OF THE INVENTION

a. Field of the Invention

The present invention generally pertains to systems used to monitor the health of a patient and more particularly to systems that include a computer program that creates and manages medical device software alerts relating to the health of a patient.

b. Description of the Background

Patients with chronic health conditions, such as diabetes, are often medicated using a closed-loop feedback system. Such a system, well-known in prior art, typically includes at least one sensor to measure important levels, a computer program that decides when a patient should receive medication based on those levels and how much medication should be given, and at least one pump to dispense the medication into a patient's bloodstream. Such sensors and pumps are constantly under development to improve their usefulness and reduce cost.

However, such feedback systems are typically designed only to monitor and control important levels from moment to moment, and computer reports generated and displayed by such a system are only snapshots of those levels at given moments. A series of such snapshots, even when examined by an experienced physician, can mask chronic problems over a period of days or weeks, such as a diabetic patient's unexpected or repeated spike or trough in blood sugar level, that can have negative health consequences if left unnoticed and untreated.

It would therefore be advantageous to have a management system, based on both a hierarchy of medical device software alert levels and of medical device software alert urgencies, that uses closed-loop feedback to detect and communicate unexpected medical levels, trends in those medical levels, and those medical levels' effects on a patient's medication and his health over a long period of time. It would be further advantageous if such a system contained a computer program that could send information about abnormalities in detected levels to appropriate stakeholders (including the patient, his caregiver and his physician) by established electronic methods of communications, including wireless methods. Such a system would not base medication delivery on levels from moment to moment but would highlight chronic problems with levels or medication that require a physician's attention.

### SUMMARY OF THE INVENTION

The present invention overcomes the disadvantages and limitations of the prior art by providing a system of using both a hierarchy of health-related alert levels and a hierarchy of health-related alert urgencies to alert a patient, his caregiver and his physician of unusual changes in the patient's health. Such a system is implemented by use of a computer program that monitors a patient's health and creates and manages alerts reflecting changes in that condition through a hierarchy. In the case of diabetes, such a system may create and manage software alerts through a hierarchy of both level and urgency that relates to a patient's blood sugar level, his weight, and/or the amount of medication delivered by a pump at any one time or over a given time period.

The present invention may therefore comprise a system that monitors changes in the health of a patient, comprising: at least one sensor that is connected to the patient and measures at least one parameter of the health of the patient; at least one medical device connected to the patient that affects at least one parameter of the health of said patient and can be affected by closed-loop feedback; a computer program that uses closed-loop feedback from data provided by the sensor and the medical device to monitor the health of the patient, generates a hierarchy of more than one level of software alerts and more than one level of software urgencies relating to the health of the patient whenever at least one parameter of the health of the patient is outside established values for the patient, uses the hierarchy to decide the seriousness and required recipients of the software alerts and the software urgencies, and transmits the software alerts and the software urgencies using wireless communications methods to stakeholders in the health of the patient; and, at least one remote electronic display that can use wireless communications methods to receive and display the set of software alerts and the set of software urgencies. The wireless communications methods may include wi-fl, e-mail, texting, cell phone, or Bluetooth. The said remote electronic display may be a smartphone or a wrist watch. The patient may have diabetes, and the hierarchy may be used by the computer program to decide the seriousness and required recipients of the software alerts and software urgencies whenever at least one parameter of the diabetic patient's health is outside of a given range established as normal for the diabetic patient.

The present invention may also comprise a method of using a computer program as part of a system to monitor changes in a patient's health, comprising: developing the computer program; connecting at least one sensor to the patient; connecting at least one medical device to the patient; using the sensor and the medical device to generate established values of medically-related conditions and ranges for the patient; combining the computer program with the sensor and the medical device so as to allow the computer program to use closed-loop feedback from data provided by the sensor and the medical device to monitor the health of the patient; using the computer program to generate a hierarchy of more than one level of software alerts and more than one level of software urgencies relating to the health of the patient whenever at least one parameter of the health of said patient is outside established values for the patient; using the hierarchy to decide the seriousness and required recipients of the software alerts and software urgencies; using the computer program to transmit the software alerts and software urgencies to stakeholders in the health of the patient using wireless communications methods; and, using a remote electronic display capable of using wireless communications methods to receive the set of software alerts and set of software urgencies and display the set of software alerts and set of software urgencies to stakeholders in the health of the patient. The wireless communications methods may include wi-fi, e-mail, texting, cell phone, or Bluetooth. The remote electronic display may be a smartphone or a wrist watch. If the patient has diabetes, the hierarchy is used by the computer program to decide the seriousness and required recipients of the software alerts and software urgencies whenever at least one parameter of the diabetic patient's health is outside of a given range established as normal for the diabetic patient.

The present invention may further comprise a computer program that uses closed-loop feedback to monitor a patient's health, comprising: establishment of baseline medically-related conditions and ranges of the patient; comparison of baseline medically-related conditions and ranges for the patient with current medically-related conditions and ranges of the patient; generation of a hierarchy of more than one level of software alerts and more than one level of software urgencies relating to the health of the patient whenever at least one parameter of the health of the patient is outside established values for the patient; use of a hierarchy to decide the seriousness and required recipients of the software alerts; use of the hierarchy to decide the seriousness and required recipients of said software urgencies; and, transmission of the software alerts and the software urgencies to a remote electronics display by use of wireless communications methods to stakeholders in the condition of the patient. The wireless communications methods may include wi-fl, e-mail, texting, cell phone, or Bluetooth. The remote electronic display may be a smartphone or a wrist watch. If the patient has diabetes, the hierarchy may be used by the computer program to decide the seriousness and required recipients of the software alerts and software urgencies whenever at least one parameter of the diabetic patient's health is outside of a given range established as normal for the diabetic patient.

The advantages of the present invention include improvements to a patient's long-term health and reduced costs of a patient's treatment regimen.

### BRIEF DESCRIPTION OF THE DRAWINGS

In the drawings,

FIG. 1 shows the system of the present invention.

FIG. 2 is a flowchart representing how a hierarchy of software alerts is created and managed by the system of the present invention.

FIG. 3 is a flowchart representing one embodiment of the system of the present invention, in which a hierarchy of software alerts for a patient with diabetes is created and managed by the system of the present invention.

FIG. 4 is a flowchart representing a hierarchy of urgencies that may be created and managed by the system of the present invention.

### DETAILED DESCRIPTION OF THE INVENTION

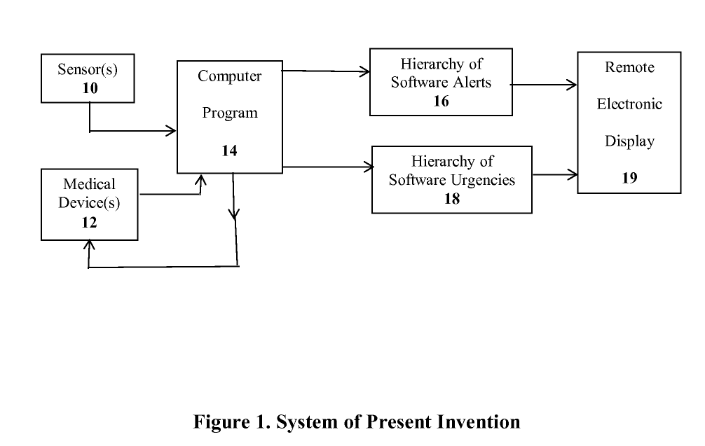

FIG. 1 shows the system of the present invention, which may include at least one sensor 10 and at least one medical device 12 that are connected to a computer program 14 that is a part of the system of the present invention. The computer program 14 may accept inputs from the sensors 10 and medical devices 12, perform calculations as needed, and provide closed-loop feedback to the medical devices 12 as needed. The computer program 14 may package the information it provides into sets of software alerts 16 and sets of software urgencies 18 and may send them as needed by various communications methods to a remote electronic display 19 so that people using the system of the present invention may monitor a patient.

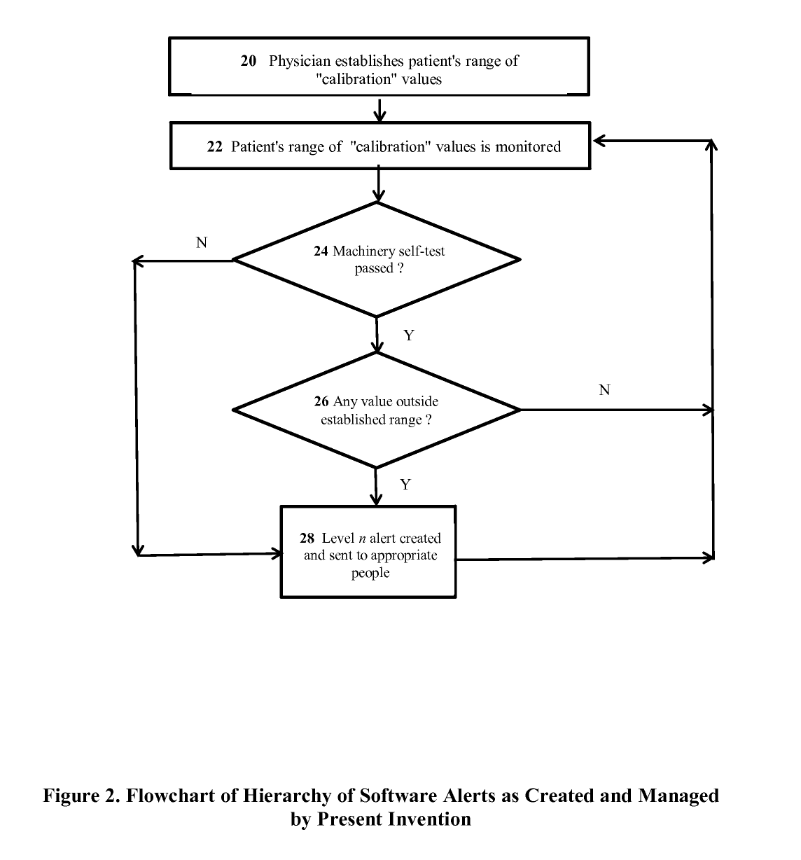

FIG. 2 illustrates a hierarchy of software alerts as created by the present invention. When a patient begins medical treatment using any kind of machinery, a physician typically establishes a range of “calibration” values 20 that are individualized and then established as “normal” for that patient. As long as each value monitored by the machinery stays within the range calibrated by the physician 22, the machinery may operate normally without creating or sending an alert. The machinery runs its own self-test regularly 24; if the self-test detects a problem with the machinery, an alert of appropriate level n (where n is any positive integer and the n possible alert levels are organized in a hierarchy of alert levels in order of importance) is created and sent 28 to appropriate people that may include the patient, a caregiver, a physician or a hospital.

Whenever any value monitored by the machinery is outside of the range calibrated by the physician 26, the system of the present invention may detect the situation and create and send an alert 28 of appropriate level n (where n is any positive integer and the n possible alerts are organized in a hierarchy of alert levels in order of importance) to appropriate people that may include the patient, a caregiver, a physician and a hospital. Thus, the present invention may create, manage, send and organize alerts in a hierarchy of alert levels to monitor the patient's health.

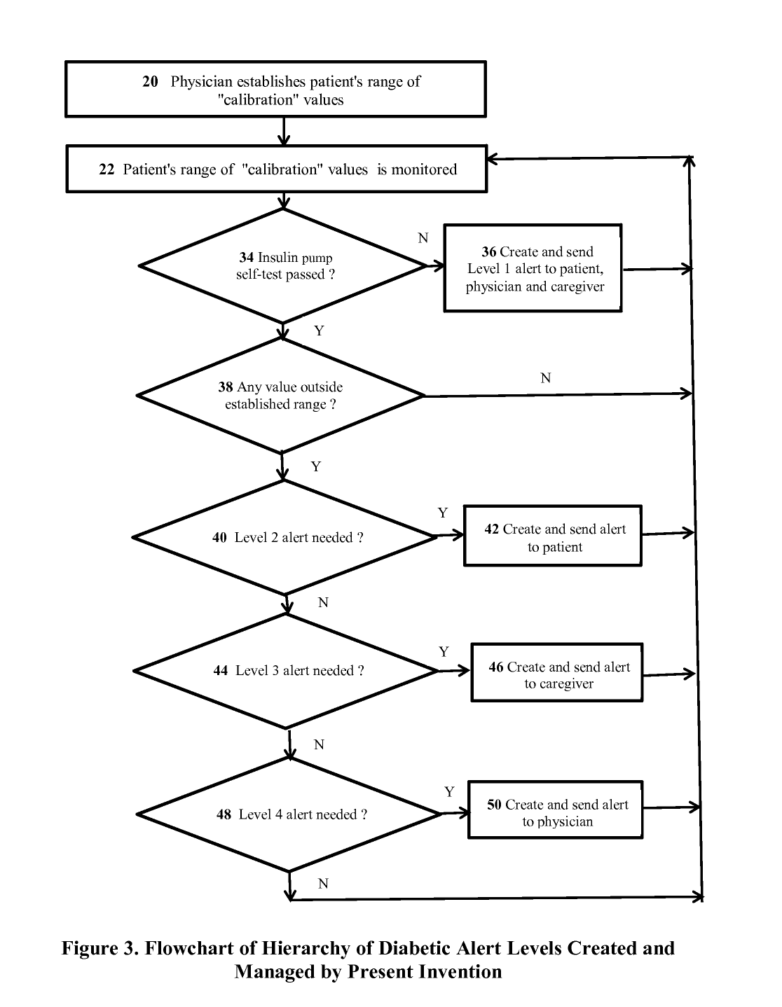

FIG. 3 is a flowchart representing one embodiment of the present invention, in which a hierarchy of alerts for a patient with diabetes is created and managed by the system of the present invention. “Calibration” values 20 generated for a patient with diabetes may include a range of normal blood sugar levels, a range of normal body weight, a range of normal amounts of medication such as insulin, and a range of normal time periods between boluses of medication. As long as each value monitored by the machinery stays within the range 22 calibrated by the physician, the machinery may operate normally without creating or sending an alert. The insulin pump used by the patient may run its own self-test regularly 34; if the self-test detects a problem with the insulin pump, a Level 1 alert 36 is created and sent to the patient, a caregiver, and a physician to indicate that the insulin pump may need repair or replacement.

When a value is detected outside the originally established range 38, the system may decide what type of alert should be created and sent. Other alerts to be created and sent may be divided into a hierarchy of Level 2 (those that only the patient needs to see) 40 and 42, Level 3 (those that a caregiver also needs to see) 44 and 46, and Level 4 (those that a physician also needs to see) 48 and 50. Such alerts may be created and sent to let the patient, his caregiver and his physician know that the physician should see the patient at the earliest opportunity to analyze and discuss the alerts and treatment regimen and make changes as needed.

One embodiment of the present invention, as applied to a patient with diabetes, may classify, create, manage and send levels of alerts in the following hierarchy:
Level 2: (patient needs to see) 40 and 42
   A) Blood sugar above calibrated range
   B) Blood sugar below calibrated range
Level 3: (caregiver needs to see) 44 and 46
   A) Blood sugar above calibrated range
   B) Blood sugar below calibrated range
Level 4: (physician needs to see) 48 and 50
   A) Body weight above calibrated range
   B) Body weight below calibrated range
   C) Daily insulin dose is less than minimum expected value
   D) Daily insulin dose is greater than maximum expected value
   E) Daily glucagon dose is less than minimum expected value
   F) Daily glucagon dose is greater than maximum expected value
   G) Daily D60 dose is less than minimum expected value
   H) Daily D60 dose is greater than maximum expected value
   I) Amount of time spent in hyperglycemic state is longer than maximum allowable time
   J) Amount of time spent in hypoglycemic state is longer than maximum allowable time
   K) Amount of medication needed to maintain normal blood sugar levels has recently increased, even if no hyperglycemic or hypoglycemic states have occurred
   L) Patient's body weight is greater than maximum expected value
   M) Patient's body weight is less than maximum expected value

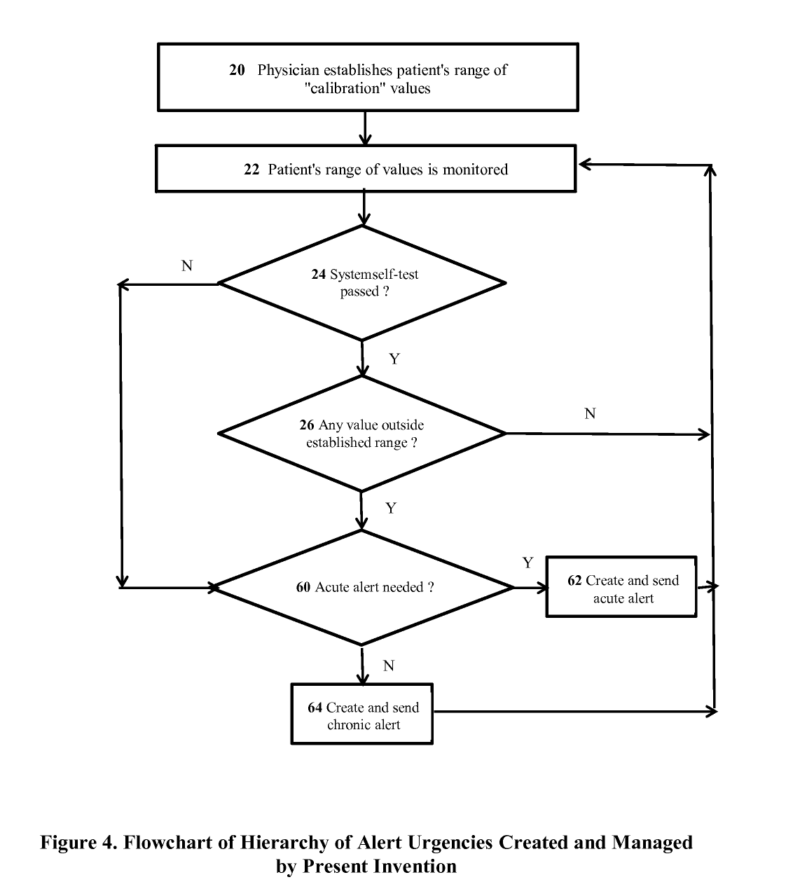

In addition to classifying alerts by level, the present invention may also create a separate hierarchy of urgencies that classifies alerts as either “acute” (requiring immediate action) or “chronic” (indicating a long-term problem). FIG. 4 illustrates a hierarchy of urgencies as created and managed by the system of the present invention. A physician may generate a range of “calibration” values 20 that are individualized and then considered “normal” for that patient. As long as each value monitored by the system of the present invention stays within the range calibrated by the physician 22, the system of the present invention may operate normally without creating or sending an alert. The system of the present invention runs its own self-test regularly 24. If the self-test detects a problem with the system, or if any value monitored by the system is outside of an established range 26, the system may classify the problem as either acute 60 and 62 or chronic 64, may create the appropriate alert, and may send it to appropriate people that may include the patient, a caregiver, a physician or a hospital. Thus, the present invention may create, manage, send and organize alerts in both a hierarchy of levels and a hierarchy of urgencies for optimum monitoring of a patient's health.

One embodiment of a hierarchy of urgencies of the present invention, as applied to a patient with diabetes, may classify, create, manage and send alerts in the following hierarchy:
Acute: (sent to patient and caregiver immediately)
   A) Blood sugar above calibrated range
   B) Blood sugar below calibrated range
Chronic: (e-mailed to physician)
   A) Body weight above calibrated range
   B) Body weight below calibrated range
   C) Daily insulin dose is less than minimum expected value
   D) Daily insulin dose is greater than maximum expected value
   E) Daily glucagon dose is less than minimum expected value
   F) Daily glucagon dose is greater than maximum expected value
   G) Daily D60 dose is less than minimum expected value
   H) Daily D60 dose is greater than maximum expected value
   I) Amount of time spent in hyperglycemic state is longer than a maximum allowable time
   J) Amount of time spent in hypoglycemic state is longer than a maximum allowable time
   K) Medication output of pump is above calibrated range
   L) Medication output of pump is above calibrated range
   M) Medication output of pump is within calibrated range but unexpectedly increases or decreases
   N) Patient's body weight is greater than maximum expected value
   O) Patient's body weight is less than maximum expected value

An alert classified as Acute may require a patient to visit a hospital or physician immediately and undergo sufficient examination to diagnose the exact nature of the problem causing the alert. An alert classified as Chronic may require a patient to make a physician's appointment and undergo sufficient examination for the physician to diagnose the exact nature of the problem causing the alert and modify the patient's treatment regimen.

In all embodiments of the present invention, alerts may be sent by common electronic communications methods, including wireless methods, that may include wi-fi, e-mail, texting, cell phone and Bluetooth. Such alerts may be seen on a remote device such as a smartphone, wrist watch or other display in a remote location and may notify all interested parties, such as a patient, caregiver, physician and hospital, of a patient's health issues. Though the general concept of sending and displaying such alerts is known in prior art, the present invention's method of managing and classifying such alerts in at least two different hierarchies, as well as the idea of sending such alerts electronically to remote locations, are both inventive steps.

The present invention therefore provides improvement to a patient's long-term health and reduced costs of a patient's treatment regimen.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A system that monitors changes in the health of a patient, comprising:
at least one sensor that is connected to said patient and measures at least one parameter of the health of said patient;
at least one medical device connected to said patient that affects at least one parameter of said health of said patient and can be affected by closed-loop feedback;
a computer program that uses closed-loop feedback from data provided by said sensor and said medical device to monitor said health of said patient, generates a hierarchy of more than one level of software alerts and more than one level of software urgencies relating to the health of said patient whenever at least one parameter of said health of said patient is outside established values for said patient, uses said hierarchy to decide the seriousness and required recipients of said software alerts and said software urgencies, and transmits said software alerts and said software urgencies using wireless communications methods to stakeholders in said health of said patient; and,
at least one remote electronic display that can use wireless communications methods to receive and display said set of software alerts and said set of software urgencies.

2. The system of claim 1, wherein said wireless communications methods include wi-fi, e-mail, texting, cell phone, or Bluetooth.

3. The system of claim 1, wherein said remote electronic display may be a smartphone or a wrist watch.

4. The system of claim 1, wherein said patient has diabetes.

5. The system of claim 4, wherein said hierarchy is used by said computer program to decide the seriousness and required recipients of said software alerts and said software urgencies whenever at least one said parameter of said diabetic patient's health is outside of a given range established as normal for said diabetic patient.

6. A method of using a computer program as part of a system to monitor changes in a patient's health, comprising:
developing said computer program;
connecting at least one sensor to said patient;
connecting at least one medical device to said patient;
using said sensor and said medical device to generate established values of medically-related conditions and ranges for said patient;
combining said computer program with said sensor and said medical device so as to allow said computer program to use closed-loop feedback from data provided by said sensor and said medical device to monitor the health of said patient;
using said computer program to generate a hierarchy of more than one level of software alerts and more than one level of software urgencies relating to the health of said patient whenever at least one parameter of said health of said patient is outside established values for said patient;
using said hierarchy to decide the seriousness and required recipients of said software alerts and said software urgencies;
using said computer program to transmit said software alerts and said software urgencies to stakeholders in said health of said patient using wireless communications methods; and,
using a remote electronic display capable of using wireless communications methods to receive said set of software alerts and said set of software urgencies and display said set of software alerts and said set of software urgencies to stakeholders in said health of said patient.

7. The method of claim 6, wherein said wireless communications methods include wi-fi, e-mail, texting, cell phone, or Bluetooth.

8. The method of claim 6, wherein said remote electronic display may be a smartphone or a wrist watch.

9. The method of claim 6, wherein said patient has diabetes.

10. The method of claim 9, wherein said hierarchy is used by said computer program to decide the seriousness and required recipients of said software alerts and said software urgencies whenever at least one said parameter of said diabetic patient's health is outside of a given range established as normal for said diabetic patient.

11. A computer program that uses closed-loop feedback to monitor a patient's health, comprising:
establishment of baseline medically-related conditions and ranges of said patient;
comparison of baseline medically-related conditions and ranges for said patient with current medically-related conditions and ranges of said patient;
generation of a hierarchy of more than one level of software alerts and more than one level of software urgencies relating to the health of said patient whenever at least one parameter of said health of said patient is outside established values for said patient;
use of a hierarchy to decide the seriousness and required recipients of said software alerts;
use of said hierarchy to decide the seriousness and required recipients of said software urgencies; and,
transmission of said software alerts and said software urgencies to a remote electronics display by use of wireless communications methods to stakeholders in said condition of said patient.

12. The computer program of claim 11, wherein said wireless communications methods include wi-fi, e-mail, texting, cell phone, or Bluetooth.

13. The computer program of claim 11, wherein said remote electronic display may be a smartphone or a wrist watch.

14. The computer program of claim 11, wherein said patient has diabetes.

15. The computer program of claim 14, wherein said hierarchy is used by said computer program to decide the seriousness and required recipients of said software alerts and said software urgencies whenever at least one said parameter of said diabetic patient's health is outside of a given range established as normal for said diabetic patient.
